(19) United States
(12) Patent Application Publication
(10) Pub. No.: US 2008/0043173 A1
(43) Pub. Date: Feb. 21, 2008

(54) Backlight module having optical sheet with optical diffusion dots and liquid crystal display using same

(75) Inventors: Yi-Fu Lin, Miao-Li (TW); Chih-Chung Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/894,130

(22) Filed: Aug. 20, 2007

(30) Foreign Application Priority Data
Aug. 18, 2006 (TW) 95130449

(51) Int. Cl. G02F 1/13357; F21V 8/00

(52) U.S. Cl. 349/65; 362/627

(57) ABSTRACT

An exemplary backlight module (22) includes a light guide plate (23), a light source (27) adjacent to a lateral side of the light guide plate, a reflector (25) under the light guide plate, and an optical dot sheet (24) between the light guide plate and the reflector. The optical dot sheet includes a transparent film (241), and numerous optical diffusion dots (244) formed on a surface of the transparent film that is adjacent to the light guide plate.

### FIELD OF THE INVENTION

The present invention relates to a backlight module having an optical sheet with optical diffusion dots, and a liquid crystal display using the backlight module.

### GENERAL BACKGROUND

A typical liquid crystal display is capable of displaying a clear and sharp image through thousands or even millions of pixels that make up the complete image. The liquid crystal display has thus been applied to various electronic equipment in which messages or pictures need to be displayed, such as mobile phones and personal computers. However, liquid crystal in the liquid crystal display does not itself emit light. Rather, the liquid crystal has to be lit up by a light source so as to clearly and sharply display text and images. The light source may be a backlight module installed with the liquid crystal display, or externally sourced light such as sunlight.

Referring to FIG. 3, a typical liquid crystal display 10 includes a liquid crystal panel 11 and a backlight module 12 adjacent to the liquid crystal panel 11. The backlight module 12 includes a light guide plate 13, a reflector 14, and a light source 18. The light guide plate 13 includes a light incident surface 131, a light emitting surface 133 adjoining the light incident surface 131, and a bottom surface 132. The light emitting surface 131 and the bottom surface 132 are at opposite sides of the light guide plate 13. The reflector 14 is located adjacent to the bottom surface 132. The light source 18 is located adjacent to the light incident surface 131. A plurality of light diffusion dots 134 are formed on the bottom surface 132 by a screen printing method. The light diffusion dots 134 are configured to diffuse light beams. A material of the light diffusion dots 134 is optical printing ink.

Light beams emitted from the light source 18 enter the light guide plate 13 through the light incident surface 131. Some of the light beams are diffused by the light diffusion dots 134 of the bottom surface 132, and then emit from the light emitting surface 133. Other light beams emit from the bottom surface 132, are reflected by the reflector 14, and reenter the light guide plate 13. These other light beams also then emit from the light emitting surface 133. Because the light diffusion dots 134 diffuse some of the light beams, the backlight module 12 is able to provide a display with uniform brightness.

Typically, the light diffusion dots 134 are made of an ordinary type of thermosetting printing ink. During mass production of the backlight module 12, the light diffusion dots 134 are liable to peel off from the bottom surface 132 of the light guide plate 13 and adhere to a top surface of the reflector 14. This is particularly the case when the ambient temperature is high. When this happens, a re-fabricating process is usually carried out. In the re-fabricating process, new light diffusion dots 134 are reprinted on the bottom surface 132 of the light guide plate 13, and the reflector 14 is discarded and replaced with a new reflector 14. Therefore the re-fabricating process is costly. In order to solve the above problems, the material of the light diffusion dots 134 should have the following characteristics: (1) avoid the so-called white cracking phenomenon; (2) have good viscosity; and (3) have proper thixotropy to obtain an accurate pattern. A special type of ultraviolet (UV) printing ink has the above characteristics, and can be used to reliably fabricate the light diffusion dots 134. However, the UV printing ink is expensive. Therefore the cost of the backlight module 12 is correspondingly high.

What is needed, therefore, is a backlight module that can overcome the above-described deficiencies. What is also needed is a liquid crystal display employing the backlight module.

### SUMMARY

In one preferred embodiment, a backlight module includes a light guide plate, a light source adjacent to a lateral side of the light guide plate, a reflector under the light guide plate, and an optical dot sheet between the light guide plate and the reflector. The optical dot sheet includes a transparent film, and a plurality of optical diffusion dots formed on a surface of the transparent film that is adjacent to the light guide plate.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, side view of a liquid crystal display according to an exemplary embodiment of the present invention, the liquid crystal display including an optical dot sheet.

FIG. 2 is a top plan view of the optical dot sheet of FIG. 1.

FIG. 3 is an exploded, side view of a conventional backlight module.

### DETAILED DESCRIPTION OF PREFERRED EMBODIMENTS

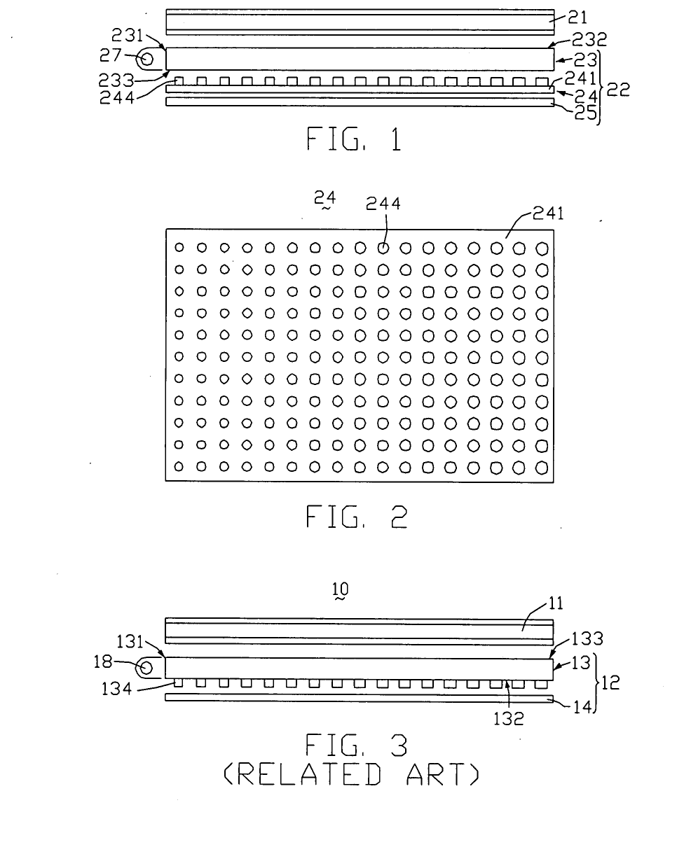

Referring to FIG. 1, this shows a liquid crystal display according to an exemplary embodiment of the present invention. The liquid crystal display 20 includes a liquid crystal panel 21, and a backlight module 22 adjacent to the liquid crystal panel 21. The backlight module 22 includes a light guide plate 23, an optical dot sheet 24, a reflector 25, and a light source 27. The light guide plate 23, the optical dot sheet 24 and the reflector 25 are stacked one on the other in that order from top to bottom. The light guide plate 23 includes a light incident surface 231, a light emitting surface 232 adjoining the light incident surface 231, and a bottom surface 233. The light emitting surface 232 and the bottom surface 233 are at opposite sides of the light guide plate 23. The optical dot sheet 24 is parallel to the bottom surface 233, and includes a transparent film 241, and a plurality of optical diffusion dots 244 formed on a surface of the transparent film 241. The optical diffusion dots 244 face the light guide plate 23. The reflector 25 is disposed adjacent to the optical dot sheet 24. The light source 27 is located adjacent to the light incident surface 231, and is configured to provide light beams for the light guide plate 23. The light guide plate 23 can be made from polymethyl methacrylate (PMMA) or polycarbonate (PC).

Referring also to FIG. 2, the optical diffusion dots 244 are arranged in a matrix on the transparent film 241. Diameters of the optical diffusion dots 244 increase with increasing distance away from the light incident surface 231. A material of the transparent film 241 has a characteristic of being stable at high ambient temperatures, such as in the range from 70° C. to 80° C. For example, the transparent film 241 can be made from polyethylene terephthalate (PET), polycarbonate (PC), or polyvinyl chloride (PVC).

Light beams emitted from the light source 27 enter the light guide plate 23 through the light incident surface 231. Some of the light beams directly propagate to the light emitting surface 232, and emit from the light emitting surface 232. Other light beams emit from the bottom surface 233, are diffused by the optical diffusing dots 244 on the optical dot sheet 24, reenter the light guide plate 23 through the bottom surface 233, and then emit from the light emitting surface 232. Still other light beams emit from a bottom of the optical dot sheet 24, are reflected by the reflector 25, return to the optical dot sheet 24 and the light guide plate 23, and emit from the light emitting surface 232.

Because the optical diffusion dots 244 are formed on the surface of the transparent film 241 facing the light guide plate 23, the optical diffusion dots 244 cannot adhere to the reflector 25 at high ambient temperatures. Accordingly, the optical diffusion dots 244 can be made from a type of thermosetting printing ink. The cost of thermosetting printing ink is approximately one third of the cost of UV printing ink. Thus, the cost of the backlight module 22 and the liquid crystal display 20 can be reduced.

Furthermore, if the backlight module 22 fails to provide a display with uniform brightness due to problems relating to the design or fabrication of the light diffusion dots 244, this difficulty can be overcome simply by replacing the optical dot sheet 24. Unlike with conventional backlight modules, there is no need to resort to costly and wasteful remedies such as re-fabricating a light guide plate with new optical diffusion dots or completely replacing the light guide plate.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A backlight module comprising:
a light guide plate;
a light source adjacent to a lateral side of the light guide plate;
a reflector under the light guide plate; and
an optical sheet between the light guide plate and the reflector, wherein the optical sheet comprises a transparent film and a plurality of optical diffusion dots formed on a surface of the transparent film that is adjacent to the light guide plate.

2. The backlight module as claimed in claim 1, wherein the optical diffusion dots are screen printed optical diffusion dots.

3. The backlight module as claimed in claim 1, wherein the optical diffusion dots are made of thermosetting printing ink.

4. The backlight module as claimed in claim 1, wherein the transparent film is made of material selected from the group consisting of polyethylene terephthalate, polycarbonate, and polyvinyl chloride.

5. The backlight module as claimed in claim 1, wherein the light guide plate comprises a light incident surface, a top light emitting surface adjacent to the light incident surface, and a bottom surface.

6. The backlight module as claimed in claim 5, wherein the optical sheet is adjacent and parallel to the bottom surface of the light guide plate.

7. The backlight module as claimed in claim 5, wherein the optical diffusion dots are arranged in a matrix.

8. The backlight module as claimed in claim 7, wherein diameters of the optical diffusion dots increase in size with increasing distance away from the light incident surface.

9. A liquid crystal display comprising:
a liquid crystal panel; and
a backlight module adjacent to the liquid crystal panel and configured for illuminating the liquid crystal panel, the backlight module comprising a light guide plate, a light source provided adjacent to a lateral side of the light guide plate, a reflector under the light guide plate, and an optical sheet between the light guide plate and the reflector;
wherein the optical sheet comprises a transparent film and a plurality of optical diffusion dots formed on a surface of the transparent film that is adjacent to the light guide plate.

10. The liquid crystal display as claimed in claim 9, wherein the optical diffusion dots are screen printed optical diffusion dots.

11. The liquid crystal display as claimed in claim 9, wherein the optical diffusion dots are made of thermosetting printing ink.

12. The liquid crystal display as claimed in claim 9, wherein the transparent film is made of material selected from the group consisting of polyethylene terephthalate, polycarbonate, and polyvinyl chloride.

13. The liquid crystal display as claimed in claim 9, wherein the light guide plate comprises a light incident surface, a top light emitting surface adjacent to the light incident surface, and a bottom surface.

14. The liquid crystal display as claimed in claim 13, wherein the optical sheet is adjacent and parallel to the bottom surface of the light guide plate.

15. The liquid crystal display as claimed in claim 13, wherein the optical diffusion dots are arranged in a matrix.

16. The liquid crystal display as claimed in claim 15, wherein diameters of the optical diffusion dots increase in size with increasing distance away from the light incident surface.

17. A backlight module comprising:
a light guide plate comprised a light emitting surface and a bottom surface adjacent to the light emitting surface;
a light source adjacent to the light emitting surface; and
an optical sheet adjacent to the bottom surface and configured to diffuse light beams emitted from the bottom surface.

18. The backlight module as claimed in claim 17, wherein the optical sheet is made of material selected from the group consisting of polyethylene terephthalate, polycarbonate, and polyvinyl chloride.

19. The backlight module as claimed in claim 17, further comprising a reflector under the optical sheet.
